(19) United States
(12) Patent Application Publication
(10) Pub. No.: US 2023/0261781 A1
(43) Pub. Date: Aug. 17, 2023

(54) COMMUNICATION METHOD AND RELATED DEVICE

(71) Applicant: HUAWEI TECHNOLOGIES CO., LTD., Shenzhen (CN)

(72) Inventors: Jia HE, Chengdu (CN); Xianfeng DU, Chengdu (CN)

(21) Appl. No.: 18/307,677

(22) Filed: Apr. 26, 2023

Related U.S. Application Data
(63) Continuation of application No. PCT/CN2021/117581, filed on Sep. 10, 2021.

(30) Foreign Application Priority Data
Oct. 27, 2020 (CN) 202011162430.5

(51) Int. Cl. H04L 1/00; G16Y 20/10

(52) U.S. Cl. CPC H04L 1/0015; G16Y 20/10

(57) ABSTRACT

Example communication methods and apparatus are described. One example method includes sending a first training signal by a first device to a second device on a reflection path. The first device sends a second training signal to the second device on the reflection path. The reflection path is a transmission path formed after the first training signal and the second training signal are reflected by a surrounding object. An interval between the first training signal and the second training signal is used to indicate to decode data.

### CROSS-REFERENCE TO RELATED APPLICATIONS

This application is a continuation of International Application No. PCT/CN2021/117581, filed on Sep. 10, 2021, which claims priority to Chinese Patent Application No. 202011162430.5, filed on Oct. 27, 2020. The disclosures of the aforementioned applications are hereby incorporated by reference in their entireties.

### TECHNICAL FIELD

This application relates to the field of communication technologies, and in particular, to a communication method and a related device.

### BACKGROUND

In scenarios such as a smart home and a smart factory, there are usually some internet of things (IoT) devices with poor single-device performance. These devices are sensitive to power consumption, and have low communication requirements, but are numerous and widely distributed. In the scenarios, a strong sensing function (radar/sensing function) is required. For example, a moving track and a lifestyle of a person are sensed to assist a healthcare application in the smart home, or a production progress is monitored by sensing a quantity of people in each area in the smart factory. Because the sensing function needs to depend on an effective reflection signal in principle, the widely distributed IoT devices are used to increase a sensing coverage of a wireless access point (AP) device, reduce a monitoring blind spot, and improve sensing performance. In addition to the sensing function, the IoT device has requirements on communication and energy consumption. Due to constraints of sensing and communication, the IoT device has low communication and sensing performance.

### SUMMARY

Embodiments of this application provide a communication method and a related device, to integrate sensing and communication functions, and reduce air interface time for data transmission by encoding data within a training signal interval.

According to a first aspect, an embodiment of this application provides a communication method, including: a first device sends a first training signal to a second device on a reflection path, and sends a second training signal to the second device on the reflection path. The reflection path is a transmission path formed after the first training signal and the second training signal are reflected by a surrounding object. There is an interval between the first training signal and the second training signal. The interval corresponds to encoded data. Data is modulated within the interval between the first training signal and the second training signal, to decouple communication and sensing functions in design, optimize the sensing function of the training signal, and implement integration of the sensing and communication functions without affecting the communication function. In addition, an IoT device can encode transmitted data within a training signal interval, to reduce air interface time.

In a possible design, the first device receives configuration information sent by the second device. The configuration information includes first indication information, and the first indication information indicates signal types of the first training signal and the second training signal. The signal type of the training signal is indicated, to distinguish different training signals.

In another possible design, one signal type corresponds to one service type, to distinguish training signals in different service scenarios.

In another possible design, one signal type corresponds to one first device, to distinguish training signals of different devices.

In another possible design, the configuration information includes second indication information, and the second indication information indicates a time period in which the first device sends the first training signal and the second training signal. Training signal processing efficiency is improved by indicating a time period for sending the training signal.

In another possible design, the configuration information further includes third indication information, and the second indication information indicates whether the first device receives downlink data sent by the second device.

In another possible design, the configuration information further includes fourth indication information, and the fourth indication information indicates at least one of uplink transmission start time, allowable transmission duration, and used frequency band information. Uplink transmission efficiency is improved based on the fourth indication information.

In another possible design, the first device disables a radio frequency circuit within the interval, and determines the interval between the first training signal and the second training signal by using a counter. A radio frequency of the IoT device can be in a sleep state within the interval, to reduce power consumption of the device.

According to a second aspect, an embodiment of this application provides a communication method, including: a second device receives a first training signal sent by a first device on a reflection path, and receives a second training signal sent by the first device on the reflection path. The reflection path is a transmission path formed after the first training signal and the second training signal are reflected by a surrounding object. The second device determines an interval between the first training signal and the second training signal, and determines decoded data based on the interval. Data is modulated within the interval between the first training signal and the second training signal, to decouple communication and sensing functions in design, optimize the sensing function of the training signal, and implement integration of the sensing and communication functions without affecting the communication function. In addition, an IoT device can encode transmitted data within a training signal interval, to reduce air interface time.

In another possible design, that the second device determines an interval between the first training signal and the second training signal includes: the second device determines a start point of a counter when the second device receives the first training signal. The second device determines an end point of the counter when the second device detects the second training signal. The second device determines the interval based on the start point and end point. The interval is determined by using the counter, to ensure accuracy of the interval.

In another possible design, the second device sends configuration information to the first device. The configuration information includes first indication information, and the first indication information indicates signal types of the first training signal and the second training signal. The signal type of the training signal is indicated, to distinguish different training signals.

In another possible design, one signal type corresponds to one service type, to distinguish training signals in different service scenarios.

In another possible design, one signal type corresponds to one first device, to distinguish training signals of different devices.

In another possible design, the configuration information includes second indication information, and the second indication information indicates a time period in which the first device sends the first training signal and the second training signal. Training signal processing efficiency is improved by indicating a time period for sending the training signal.

In another possible design, the configuration information further includes third indication information, and the second indication information indicates whether the first device receives downlink data sent by the second device.

In another possible design, the configuration information further includes fourth indication information, and the fourth indication information indicates at least one of uplink transmission start time, allowable transmission duration, and used frequency band information. Uplink transmission efficiency is improved based on the fourth indication information.

According to a third aspect, an embodiment of this application provides a communication apparatus. The communication apparatus is configured to implement the method and functions performed by the first device in the first aspect. The method and functions are implemented by hardware/software. The hardware/software includes modules corresponding to the foregoing functions.

According to a fourth aspect, an embodiment of this application provides a communication apparatus. The communication apparatus is configured to implement the method and functions performed by the second device in the second aspect. The method and functions are implemented by hardware/software. The hardware/software includes modules corresponding to the foregoing functions.

According to a fifth aspect, an embodiment of this application provides a communication apparatus used in a first device. The communication apparatus may be the first device or a chip in the first device, and includes a processor, a memory, and a communication bus. The communication bus is configured to implement connection and communication between the processor and the memory. The processor executes a program stored in the memory, to implement the steps in the first aspect.

According to a sixth aspect, an embodiment of this application provides a communication apparatus used in a second device. The communication apparatus may be the second device or a chip in the second device, and includes a processor, a memory, and a communication bus. The communication bus is configured to implement connection and communication between the processor and the memory. The processor executes a program stored in the memory, to implement the steps in the second aspect.

According to a seventh aspect, an embodiment of this application further provides a computer-readable storage medium. The computer-readable storage medium stores instructions. When the instructions are run on a computer, the computer is enabled to perform the method according to the foregoing aspects.

According to an eighth aspect, this application provides a computer program product including instructions. When the computer program product runs on a computer, the computer is enabled to perform the method according to the foregoing aspects.

According to a ninth aspect, an embodiment of this application provides a chip. The chip includes a processor, configured to: invoke instructions from a memory and run the instructions stored in the memory, so that a first device or a second device in which the chip is installed performs the method according to any one of the foregoing aspects.

According to a tenth aspect, an embodiment of this application provides another chip, including an input interface, an output interface, a processor, and optionally, a memory. The input interface, the output interface, the processor, and the memory are connected by using an internal connection path. The processor is configured to execute code in the memory. When the code is executed, the processor is configured to perform the method according to any of the foregoing aspects.

According to an eleventh aspect, an embodiment of this application provides a communication system. The communication system includes at least one first device and at least one second device. The first device is configured to perform the steps in the first aspect, and the second device is configured to perform the steps in the second aspect.

### BRIEF DESCRIPTION OF DRAWINGS

To describe the technical solutions in embodiments of this application or the background more clearly, the following describes the accompanying drawings used in embodiments of this application or the background:

FIG. 1 is a schematic diagram of a structure of a communication system according to an embodiment of this application;

FIG. 2 is a schematic diagram of a signal design;

FIG. 3 is a schematic diagram of another signal design;

FIG. 4 is a schematic diagram of still another signal design;

FIG. 5 is a schematic flowchart of a communication method according to an embodiment of this application;

FIG. 6 is a schematic diagram of a training signal time period according to an embodiment of this application;

FIG. 7 is a flowchart of a communication time sequence according to an embodiment of this application;

FIG. 8 is a schematic diagram of a structure of an indication frame according to an embodiment of this application;

FIG. 9 is a schematic diagram of uplink transmission according to an embodiment of this application;

FIG. 10 is a schematic diagram of a communication method according to an embodiment of this application;

FIG. 11 is a schematic diagram of a structure of a communication apparatus according to an embodiment of this application;

FIG. 12 is a schematic diagram of a structure of another communication apparatus according to an embodiment of this application;

FIG. 13 is a schematic diagram of a structure of a first device according to an embodiment of this application; and

FIG. 14 is a schematic diagram of a structure of a second device according to an embodiment of this application.

### DESCRIPTION OF EMBODIMENTS

The following describes embodiments of this application with reference to the accompanying drawings in embodiments of this application:

FIG. 1 is a schematic diagram of a structure of a communication system according to an embodiment of this application. The communication system includes a plurality of IoT devices (for example, an IoT device 1, an IoT device 2, and an IoT device 3) and an access point (AP) device. The AP device can be connected to the plurality of IoT devices through a wireless network (for example, Wi-Fi). An AP is an access point of a wireless network, commonly known as a “hot spot”, and can be used as a central point of a wireless local area network, so that another device (for example, an IoT device) installed with a wireless communication module can access the wireless local area network. The IoT device is a device that combines a sensor and a wireless communication module (for example, a Wi-Fi module), for example, a wearable device, a smart vehicle-mounted device, or a smart device in a home network (for example, a smart desk lamp, a smart refrigerator, a smart television, a smart washing machine, a smart air conditioner, or a smart air purifier). The AP device can control the IoT device connected to the AP device and a quantity of connected IoT devices, to reduce a load of the AP device.

The IoT device can communicate with the AP device on a direct path, or can communicate with the AP device on a reflection path. The direct path indicates that a signal sent by the IoT device is directly sent to the AP device without passing through any device. The reflection path indicates a transmission path formed after a signal sent by the IoT device is reflected by a surrounding object. A task of sensing an environment is accomplished through reflection. The surrounding object may be a person or another device.

In embodiments of this application, the technical solutions in this application are described by using the IoT device as a first device and the AP device as a second device. Details are not described below again.

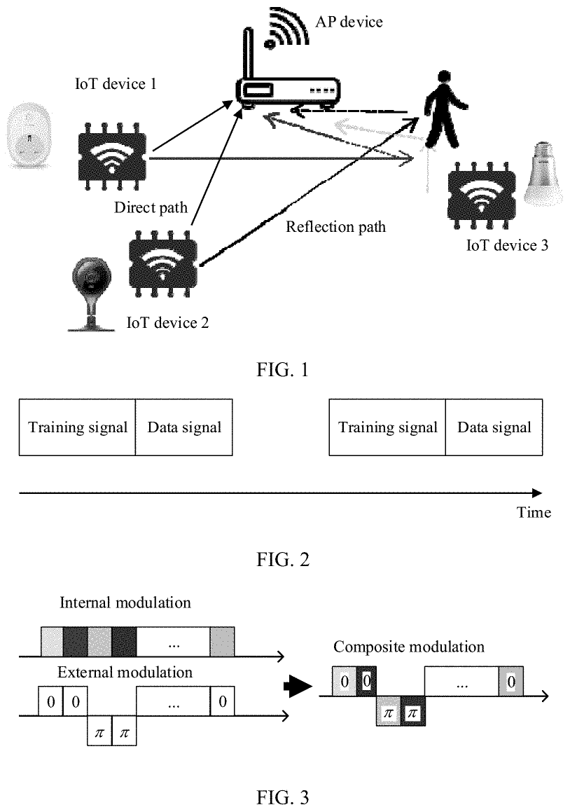

FIG. 2 is a schematic diagram of a signal design. A signal includes a training signal and a data signal. The training signal is used to sense an ambient environment, and the data signal is used to transmit data. For example, the signal may be a Wi-Fi signal. The training signal is a preamble of the Wi-Fi signal. Sensing is performed based on measured channel state information (CSI). The data signal includes transmitted data. However, in addition to a sensing function, the training signal is usually used for channel estimation during decoding of the data signal. Therefore, a signal design of the training signal is restricted by sensing and communication requirements, and cannot be optimized completely based on the sensing function.

FIG. 3 is a schematic diagram of another signal design. A signal meets communication and sensing requirements through composite modulation. For internal modulation, a set of completely orthogonal symbols are used to encode data. For external modulation, on the basis of internal modulation, a phase of an internal symbol is modulated based on a sequence suitable for a sensing function, for example, a barker sequence. However, because an internally modulated symbol is of approximate orthogonality rather than ideal orthogonality, sensing performance is affected when more digits are modulated.

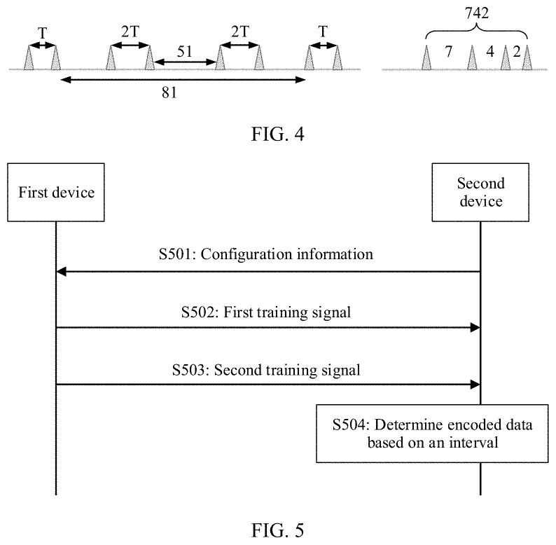

FIG. 4 is a schematic diagram of still another signal design. A signal is used to transmit data through interval modulation of a pulse signal. As shown in the left part in FIG. 4, coding efficiency is improved by inserting a short interval into a long interval. For example, the long interval (81) means that two pairs of pulses within an interval of T indicate a start and an end, and the short interval (51) means that two pairs of pulses within an interval of 2T indicate a start and an end. As shown in a right part in FIG. 4, a plurality of short intervals are used to jointly represent a large number, to improve coding efficiency of interval modulation. However, according to this solution, integration of sensing and communication function cannot be implemented.

To resolve the foregoing technical problem, this application provides the following solution:

FIG. 5 is a schematic flowchart of a communication method according to an embodiment of this application. Steps in this embodiment of this application include:

S501: a second device sends configuration information to a first device.

The configuration information may be an indication frame.

Optionally, the configuration information includes first indication information, and the first indication information indicates a signal type of a training signal sent by the first device. The training signal includes a first training signal and a second training signal. The first indication information may be a training identifier (Training ID). For example, the training ID may include a training 1 id and a training 2 id that respectively indicate signal types of a training signal 1 and a training signal 2.

Optionally, one signal type corresponds to one service type. In different application scenarios, data of different service types may be used, and training signals of different sensing tasks may be selected.

Optionally, one signal type corresponds to one first device. When an AP device needs to communicate with a plurality of IoT devices, different IoT devices may use different training signals, to distinguish between different IoT devices.

Optionally, when the AP device needs to communicate with the plurality of IoT devices, different IoT devices may send training signals in a space division, time division, and code division combination manner. It should be noted that one of the IoT devices may send the training signal in each sending period, or may not send the training signal in the sending period.

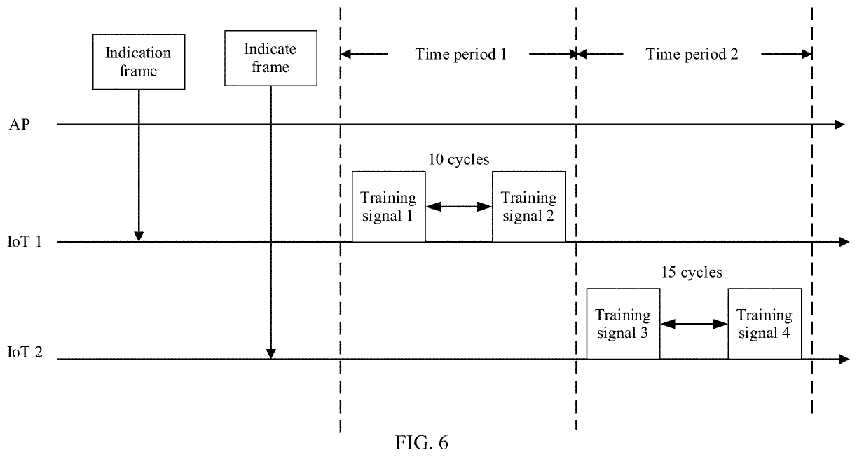

Optionally, the configuration information includes second indication information, and the second indication information indicates a time period in which the first device sends the first training signal and the second training signal. For example, FIG. 6 is a schematic diagram of a training signal time period according to an embodiment of this application. The configuration information may include a time period 1 in which an IoT device 1 sends a training signal and a time period 2 in which an IoT device 2 sends a training signal. In the time period 1, the IoT device 1 may send a training signal 1 and a training signal 2. In the time period 2, the IoT device 2 may send a training signal 3 and a training signal 4. Optionally, the training signal sent by the IoT device 1 and the training signal sent by the IoT device 2 may belong to a same signal type, or may belong to different signal types.

Optionally, the configuration information further includes third indication information, and the second indication information indicates whether the first device receives downlink data sent by the second device. The third indication information may be a downlink indicator (DL indicator). The downlink data may be a downlink frame (DL frame). The first device may receive, based on the third indication information, the downlink data sent by the first device. If the third indication information indicates the first device to receive the downlink data sent by the second device, the second device may first send the downlink data, and then the first device sends uplink data. Certainly, the first device may first send uplink data, and then the second device sends the downlink data.

It should be noted that the AP device needs to be responsible for a sensing task, but the IoT device does not need to be responsible for the sensing task. Therefore, the IoT device needs to send the first training signal and the second training signal in sequence, to send encoded data to the AP device for sensing and decoding, but there is no requirement for downlink data sent by the AP device.

Optionally, the first device or the second device may determine a sending period of a training signal based on an indication of the downlink frame. For example, a moment at which the AP device completes sending a first downlink frame may be used as a start point of the sending period of the training signal, and a moment at which the AP device starts to send a second downlink frame may be used as an end point of the sending period of the training signal.

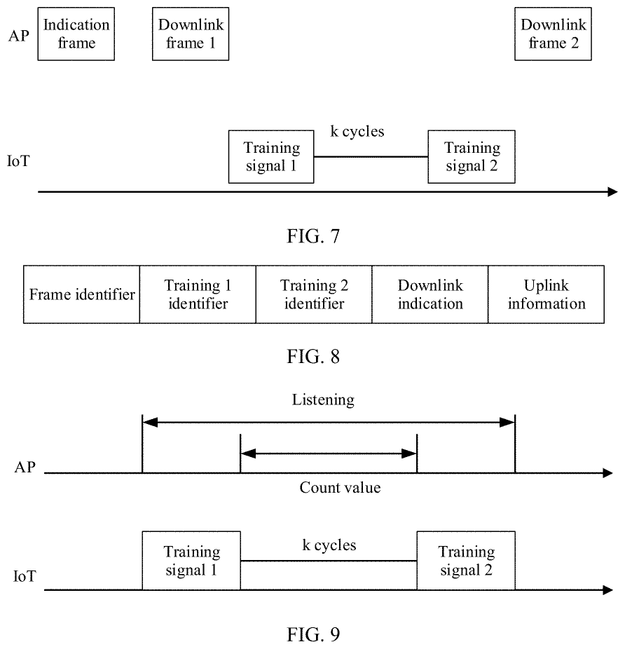

FIG. 7 is a flowchart of a communication time sequence according to an embodiment of this application. The AP device first sends the indication frame. The indication frame indicates that the IoT device needs to receive a downlink frame sent by the AP device. After receiving a downlink frame 1, the IoT device starts to send the training signal 1 to the AP device. After k cycles, the IoT device sends the training signal 2 to the AP device. After the IoT device receives a downlink frame 2, a transmission period of the training signals ends.

Optionally, the configuration information further includes fourth indication information, and the fourth indication information indicates at least one of uplink transmission start time, allowable transmission duration, and used frequency band information. The fourth indication information may be uplink information (UL info).

FIG. 8 is a schematic diagram of a structure of an indication frame according to an embodiment of this application. A frame structure of the indication frame may include a frame identifier (frame ID), a training identifier (training ID), a downlink indicator (DL indicator), and uplink information (UL info). The frame identifier indicates a type of the frame. The training identifier may include the training 1 ID and the training 2 ID that indicate signal types of the first training signal and the second training signal. The downlink indicator indicates whether there is downlink data. The uplink information indicates information such as the uplink transmission start time, the allowable duration, the used frequency band, and the like.

S502: the first device sends the first training signal to the second device on a reflection path.

S503: the first device sends the second training signal to the second device on the reflection path.

The first training signal and the second training signal may be sent in a preset sequence. The sensing task may be completed by using the first training signal and the second training signal. For example, when the first training signal and the second training signal are reflected by a person and transmitted to the AP device, the AP device may analyze physical properties of the reflected first training signal and second training signal, and determine a location, a movement direction, a movement speed, and the like of the person.

Optionally, the first device disables a radio frequency circuit within an interval, and determines an interval between the first training signal and the second training signal by using a counter, so that a radio frequency of the first device may be in a sleep state. This reduces power consumption of the device.

Optionally, the second device determines a start point of the counter when the second device receives the first training signal. The second device determines an end point of the counter when the second device detects the second training signal. The second device determines the interval between the first training signal and the second training signal based on the start point and the end point. The interval corresponds to one piece of encoded data. The interval may be k cycles, and k may be an integer greater than or equal to 0.

Optionally, the second device may listen on the first device before the first device sends the first training signal, and stop listening to a training signal after the second device receives the second training signal.

For example, FIG. 9 is a schematic diagram of uplink transmission according to an embodiment of this application. Before receiving the training signal 1, the AP device starts to listen to a signal from the IoT device. When receiving all training signals 1, the AP device sets the start point of the counter, and continues to listen to the signal from the IoT device. When detecting a training signal 2 sent by the IoT device, the AP device sets the end point of the counter. The interval can be determined by the start point and the end point of the counter.

S504: the second device determines the interval between the first training signal and the second training signal, and determines decoded data based on the interval.

For example, for a thermometer (an IoT device), the thermometer can transmit a temperature value of −30° C. to 30° C. The temperature range can be divided into 60 equal parts. −30° C. corresponds to an interval 0, −29° C. corresponds to an interval 1, −28° C. corresponds to an interval 2, and so on. Each time the interval is incremented by 1, the temperature value is incremented by 1. If the AP device receives the first training signal and the second training signal, and determines that the interval between the first training signal and the second training signal is 50 cycles (encoded data), the AP device may determine that the decoded data is 20° C. For another example, when the AP device determines that the interval between the first training signal and the second training signal is 2, it may be determined that the IoT device performs encoding by using two bits. Therefore, the AP device may decode, based on the two bits, the received uplink data sent by the IoT device.

Optionally, each first device may send training signals of different signal types in a time period, and the second device may receive, in different time periods, training signals sent by a plurality of first devices. By detecting the intervals between the first training signals and the second training signals in different time periods, the encoded data transmitted by the plurality of first devices is determined, and physical properties of the training signals are analyzed to complete a sensing function.

For example, as shown in FIG. 6, if indirect mapping between the plurality of IoT devices and the AP device is used as an encoding scheme, it is assumed that encode(23)=10 and encode(55)=15. The AP device separately sends an indication frame to the IoT device 1 and the IoT device 2. The IoT device 1 and the IoT device 2 separately determine, based on the indication frame, a time period for sending a training signal and a signal type. The IoT device 1 sends the training signal 1 and the training signal 2 to the AP device in the time period 1. After receiving the training signal 1 and the training signal 2, the AP device determines that an interval between the training signal 1 and the training signal 2 is 10 cycles. The AP device can determine, based on the interval of 10, that the decoded data is 23. The IoT device 2 sends the training signal 3 and the training signal 4 to the AP device in the time period 2. After receiving the training signal 3 and the training signal 4, the AP device determines that an interval between the training signal 3 and the training signal 4 is 15 cycles. The AP device can determine, based on the interval of 15, that the decoded data is 55. Signal types of the training signals sent by the IoT device 1 and the IoT device 2 may be different or the same. A length of the time period 1 and a length of the time period 2 may also be the same or different.

Optionally, the first device may adjust the interval between the first training signal and the second training signal based on a signal type that is of the training signal and that is indicated by the configuration information. The second device determines different decoded data based on different intervals.

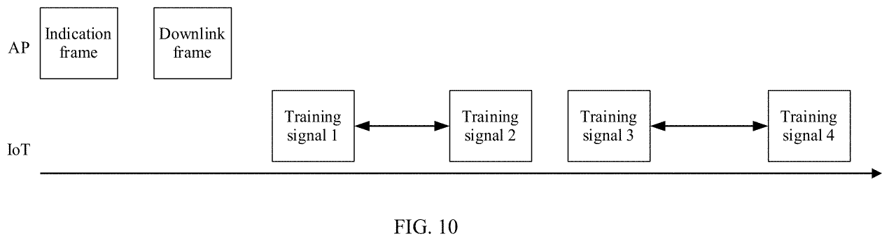

For example, FIG. 10 is a schematic diagram of a communication method according to an embodiment of this application. An IoT device first receives an indication frame sent by an AP device, and determines, based on the indication frame, to receive a downlink frame sent by the AP device. In addition, the IoT device may determine a signal type of a training signal based on the indication frame. In addition, based on the indication frame, the IoT device sends a training signal 1 and a training signal 2 to the AP device in a time period 1, adjusts an interval after sending the training signals in the time period 1, and sends a training signal 3 and a training signal 4 to the AP device in a time period 2. The AP device may determine, based on the training signal 1 and the training signal 2 in the time period 1, that data sent by the IoT device is 23, and determine, based on the training signal 3 and the training signal 4 in the time period 2, that the data sent by the IoT device is 55. Alternatively, the AP device can analyze a physical property of the training signal sent by the IoT device to complete a sensing function. For example, a location, a moving track, and the like of a reflected object are determined.

It should be noted that a transmission rate of interval modulation is related to clock frequencies of a first device and a second device. For data of different service types, the data may be modulated and transmitted on a premise that transmission rate requirements of the first device and the second device are met. If the clock frequency fc=16,777,216 Hz, and each increment of a clock cycle represents a value, time of one second may represent 16,777,216 different values, that is, log 2 (16,777,216)=−24 bits. Therefore, the transmission rate r=#bits/(cycle_info/fc), and cycle_info is a quantity of clock cycles mapped to the data, it is assumed that 2^{d} is a maximum number of values that can be represented. For an evenly distributed data, average (cycle_info)=2^{d-1}. Therefore, a desired transmission rate is r=24*16,777,216/223=48 bits/s. Therefore, a transmission rate of interval-modulated data is not greater than 48 bits/s.

Optionally, coding may be formulated based on prior knowledge of data distribution of transmitted data. A function of the training signal is improved by adjusting a training signal interval. In addition, the transmission rate is improved by transmitting data within a short interval in more time periods. For example, if return data of a thermometer ranges from 0 to 40, and the data is normally distributed, data with higher expectations can be mapped to shorter interval lengths and data with lower expectations can be mapped to longer interval lengths.

In an actual system, the AP device and the IoT device can negotiate the encoding scheme based on a device type and a task scenario after the AP device is associated with the IoT device or before data is transmitted. In the coding scheme, a minimum difference between two adjacent cycle_info can be set, to reduce a decoding error caused by a clock offset.

In this embodiment of this application, data is modulated within the interval between the first training signal and the second training signal, to decouple communication and sensing functions in design, optimize the sensing function of the training signal, and implement integration of the sensing and communication functions without affecting the communication function. In addition, the IoT device can encode transmitted data within a training signal interval, to reduce air interface time. A radio frequency of the IoT device can be in a sleep state within the interval, to reduce power consumption of the device.

The foregoing describes in detail the method in embodiments of this application, and the following describes an apparatus provided in embodiments of this application:

FIG. 11 is a schematic diagram of a structure of a communication apparatus according to an embodiment of this application. The communication apparatus may be an IoT device, a chip in the IoT device, or a processing system in the IoT device. The apparatus may be configured to implement any method and function of the IoT device in any one of the foregoing embodiments. The apparatus may include a sending module 1101, a receiving module 1102, and a processing module 1103. Optionally, the sending module 1101 and the receiving module 1102 respectively correspond to a radio frequency circuit and a baseband circuit that are included in the IoT device. Each module is described in detail as follows:

The sending module 1101 is configured to send a first training signal to a second device on a reflection path.

The sending module 1101 is further configured to send a second training signal to the second device on the reflection path.

The reflection path is a transmission path formed after the first training signal and the second training signal are reflected by a surrounding object. There is an interval between the first training signal and the second training signal. The interval corresponds to encoded data.

Optionally, the receiving module 1102 is configured to receive configuration information sent by the second device. The configuration information includes first indication information, and the first indication information indicates signal types of the first training signal and the second training signal.

Optionally, one signal type corresponds to one service type.

Optionally, one signal type corresponds to one first device.

Optionally, the configuration information includes second indication information, and the second indication information indicates a time period in which the first device sends the first training signal and the second training signal.

Optionally, the configuration information further includes third indication information, and the second indication information indicates whether the first device receives downlink data sent by the second device.

Optionally, the configuration information further includes fourth indication information, and the fourth indication information indicates at least one of uplink transmission start time, allowable transmission duration, and used frequency band information.

Optionally, the processing module 1103 is configured to: disable a radio frequency circuit within the interval, and determine the interval between the first training signal and the second training signal by using a counter.

It should be noted that, for implementation of each module, the method and functions performed by the IoT device in the foregoing embodiment are performed by referring to corresponding descriptions in the method embodiment shown in FIG. 5.

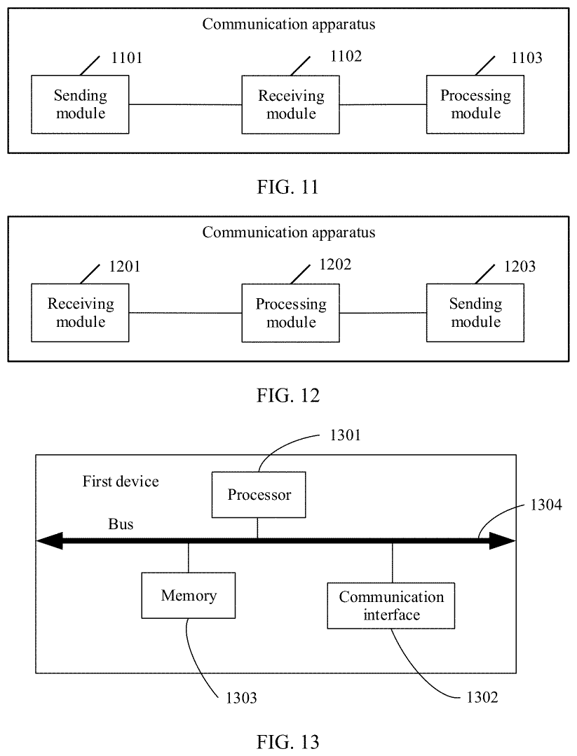

FIG. 12 is a schematic diagram of a structure of another communication apparatus according to an embodiment of this application. The communication apparatus may be an AP device, a chip in the AP device, or a processing system in the AP device. The apparatus may be configured to implement any method and function of the AP device in any one of the foregoing embodiments. The apparatus may include a receiving module 1201, a processing module 1202, and a sending module 1203. Optionally, the receiving module 1201 and the sending module 1203 respectively correspond to a radio frequency circuit and a baseband circuit that are included in the AP device. Each module is described in detail as following:

The receiving module 1201 is configured to receive a first training signal sent by a first device on a reflection path.

The receiving module 1201 is further configured to receive a second training signal sent by the first device on the reflection path. The reflection path is a transmission path formed after the first training signal and the second training signal are reflected by a surrounding object.

The processing module 1202 is configured to determine an interval between the first training signal and the second training signal, and determine decoded data based on the interval.

Optionally, the processing module 1202 is further configured to: determine a start point of a counter when a second device receives the first training signal, determine an end point of the counter when the second device detects the second training signal, and determine the interval based on the start point and the end point.

Optionally, the sending module 1203 is configured to send configuration information to the first device. The configuration information includes first indication information, and the first indication information indicates signal types of the first training signal and the second training signal.

Optionally, one signal type corresponds to one service type.

Optionally, one signal type corresponds to one first device.

Optionally, the configuration information includes second indication information, and the second indication information indicates a time period in which the first device sends the first training signal and the second training signal.

Optionally, the configuration information further includes third indication information, and the second indication information indicates whether the first device receives downlink data sent by the second device.

Optionally, the configuration information further includes fourth indication information, and the fourth indication information indicates at least one of uplink transmission start time, allowable transmission duration, and used frequency band information.

It should be noted that, for implementation of each module, the method and functions performed by the AP device in the foregoing embodiment are performed by referring to corresponding descriptions in the method embodiment shown in FIG. 5.

FIG. 13 is a schematic diagram of a structure of a first device according to an embodiment of this application. The first device may be an IoT device, and include at least one processor 1301, at least one communication interface 1302, at least one memory 1303, and at least one communication bus 1304.

The processor 1301 may be a central processing unit, a general-purpose processor, a digital signal processor, an application-specific integrated circuit, a field programmable gate array or another programmable logic device, a transistor logic device, a hardware component, or any combination thereof. The processor may implement or execute various example logical blocks, modules, and circuits described with reference to content disclosed in this application. The processor may alternatively be a combination for implementing a computing function, for example, a combination including one or more microprocessors or a combination of a digital signal processor and a microprocessor. The communication bus 1304 may be a peripheral component interconnect PCI (Peripheral Component Interconnect) bus, an extended industry standard architecture EISA bus, or the like. The bus may be classified into an address bus, a data bus, a control bus, and the like. For ease of representation, only one thick line is for representing the bus in FIG. 13, but this does not mean that there is only one bus or only one type of bus. The communication bus 1304 is configured to implement connection and communication between these components. The communication interface 1302 of the device in this embodiment of this application is configured to perform signaling or data communication with another node device. The memory 1303 may include a volatile memory such as a nonvolatile random access memory (NVRAM), a phase change random access memory (PRAM), or a magnetoresistive random access memory (MRAM), and may further include a nonvolatile memory such as at least one magnetic disk storage device, an electrically erasable programmable read-only memory (EEPROM), a flash memory device such as a NOR flash memory or a NAND flash memory, or a semiconductor device such as a solid state disk (SSD). Optionally, the memory 1303 may be at least one storage apparatus disposed far away from the processor 1301. Optionally, the memory 1303 may further store a group of program code. Optionally, the processor 1301 may further execute a program stored in the memory 1303.

A first training signal is sent to a second device on a reflection path.

A second training signal is sent to the second device on the reflection path.

The reflection path is a transmission path formed after the first training signal and the second training signal are reflected by a surrounding object. There is an interval between the first training signal and the second training signal. The interval corresponds to encoded data.

Optionally, the processor 1301 is further configured to perform the following operation:

receiving configuration information sent by the second device, where the configuration information includes first indication information, and the first indication information indicates signal types of the first training signal and the second training signal.

Optionally, one signal type corresponds to one service type.

Optionally, one signal type corresponds to one first device.

Optionally, the configuration information includes second indication information, and the second indication information indicates a time period in which the first device sends the first training signal and the second training signal.

Optionally, the configuration information further includes third indication information, and the second indication information indicates whether the first device receives downlink data sent by the second device.

Optionally, the configuration information further includes fourth indication information, and the fourth indication information indicates at least one of uplink transmission start time, allowable transmission duration, and used frequency band information.

Optionally, the processor 1301 is further configured to perform the following operations:

disabling a radio frequency circuit within the interval, and determining the interval between the first training signal and the second training signal by using a counter.

The processor can cooperate with the memory and the communication interface to perform any method and function of the first device in embodiments of this application.

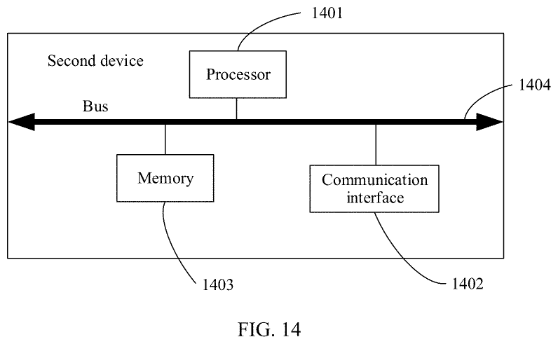

FIG. 14 is a schematic diagram of a structure of a second device according to an embodiment of this application. The second device may be an AP device, and include at least one processor 1401, at least one communication interface 1402, at least one memory 1403, and at least one communication bus 1404.

The processor 1401 may be various types of processors mentioned above. The communication bus 1404 may be a peripheral component interconnect PCI bus, an extended industry standard architecture EISA bus, or the like. The bus may be classified into an address bus, a data bus, a control bus, and the like. For ease of representation, only one thick line is for representing the bus in FIG. 14, but this does not mean that there is only one bus or only one type of bus. The communication bus 1404 is configured to implement connection and communication between these components. The communication interface 1402 of the device in this embodiment of this application is configured to perform signaling or data communication with another node device. The memory 1403 may be various types of memories mentioned above. Optionally, the memory 1403 may be at least one storage apparatus disposed far away from the processor 1401. The memory 1403 stores a group of program code, and the processor 1401 executes a program in the memory 1403.

A first training signal sent by a first device is received on a reflection path.

A second training signal sent by the first device is received on the reflection path. The reflection path is a transmission path formed after the first training signal and the second training signal are reflected by a surrounding object.

An interval between the first training signal and the second training signal is determined. Decoded data is determined based on the interval.

Optionally, the processor 1401 is further configured to perform the following operations:

determining a start point of a counter when the second device receives the first training signal;

determining an end point of the counter when the second device detects the second training signal; and

determining the interval based on the start point and the end point.

Optionally, the processor 1401 is further configured to perform the following operation:

sending configuration information to the first device, where the configuration information includes first indication information, and the first indication information indicates signal types of the first training signal and the second training signal.

Optionally, one signal type corresponds to one service type.

Optionally, one signal type corresponds to one first device.

Optionally, the configuration information includes second indication information, and the second indication information indicates a time period in which the first device sends the first training signal and the second training signal.

Optionally, the configuration information further includes third indication information, and the second indication information indicates whether the first device receives downlink data sent by the second device.

Optionally, the configuration information further includes fourth indication information, and the fourth indication information indicates at least one of uplink transmission start time, allowable transmission duration, and used frequency band information.

The processor can cooperate with the memory and the communication interface to perform any method and function of the second device in embodiments of this application.

An embodiment of this application further provides a chip system. The chip system includes a processor, configured to support a first device or a second device in implementing a function in any one of the foregoing embodiments, for example, generating or processing a training signal in the foregoing methods. In a possible design, the chip system may further include a memory, and the memory is configured to store a program instruction and data that are necessary for the first device or the second device. The chip system may include a chip, or may include a chip and another discrete component.

An embodiment of this application further provides a processor, configured to be coupled to a memory, and configured to perform any method and function of a first device or a second device in any one of the foregoing embodiments.

An embodiment of this application further provides a computer program product including instructions. When the computer program product runs on a computer, the computer is enabled to perform any method and function of a first device or a second device in any one of the foregoing embodiments.

An embodiment of this application further provides an apparatus, configured to perform any method and function of a first device or a second device in any one of the foregoing embodiments.

An embodiment of this application further provides a wireless communication system. The system includes at least one first device and at least one second device in any one of the foregoing embodiments.

It may be clearly understood by a person skilled in the art that, for the purpose of convenient and brief description, for a detailed working process of the foregoing communication apparatus and the units or modules in the apparatus, refer to a corresponding process in the foregoing method embodiments. Details are not described herein again.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a dedicated computer, a computer network, or another programmable apparatus. The computer instructions may be stored in the computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a DVD), a semiconductor medium (for example, a solid state disk (solid state disk, SSD)), or the like.

It should be understood that the term “and/or” in this specification describes only an association relationship between associated objects and represents that three relationships may exist. For example, A and/or B may represent the following three cases: only A exists, both A and B exist, and only B exists.

It should be understood that, in embodiments of this application, “B corresponding to A” indicates that B is associated with A, and B may be determined based on A. However, it should be further understood that, determining B based on A does not mean that B is determined only based on A, and B may also be determined based on A and/or other information.

In embodiments of this application, “a plurality of” means two or more.

Descriptions such as “first” and “second” in embodiments of this application are only used as examples and used to distinguish between objects, but do not indicate a sequence or indicate a specific limitation on a quantity of objects in embodiments of this application, and cannot constitute any limitation on embodiments of this application.

It may be understood that, in embodiments of this application, the first device and/or the second device may perform some or all of the steps in embodiments of this application. These steps or operations are merely examples. Other operations or variations of various operations may be further performed in embodiments of this application. In addition, the steps may be performed in a sequence different from that shown in embodiments of this application, and possibly, not all the operations in embodiments of this application need to be performed.

The objectives, technical solutions, and beneficial effect of this application are further described in detail in the foregoing specific implementations. Any modification, equivalent replacement, and improvement made without departing from the principle of this application shall fall within the protection scope of this application.

What is claimed is:

1. A communication method, comprising:
sending, by a first device, a first training signal to a second device on a reflection path; and
sending, by the first device, a second training signal to the second device on the reflection path, wherein the reflection path is a transmission path formed after the first training signal and the second training signal are reflected by a surrounding object, and wherein an interval between the first training signal and the second training signal corresponds to encoded data.

2. The communication method according to claim 1, wherein the communication method further comprises:
receiving, by the first device, configuration information sent by the second device, wherein the configuration information comprises first indication information, and the first indication information indicates signal types of the first training signal and the second training signal.

3. The communication method according to claim 2, wherein one of the signal types corresponds to one service type.

4. The communication method according to claim 2, wherein one of the signal types corresponds to one first device.

5. The communication method according to claim 2, wherein the configuration information comprises second indication information, and the second indication information indicates a time period in which the first device sends the first training signal and the second training signal.

6. The communication method according to claim 2, wherein the configuration information further comprises third indication information, and the third indication information indicates whether the first device receives downlink data sent by the second device.

7. The communication method according to claim 2, wherein the configuration information further comprises fourth indication information, and the fourth indication information indicates at least one of uplink transmission start time, allowable transmission duration, or used frequency band information.

8. The communication method according to claim 1, wherein the communication method further comprises:
disabling, by the first device, a radio frequency circuit within the interval; and
determining, by the first device, the interval between the first training signal and the second training signal by using a counter.

9. A communication apparatus, wherein the communication apparatus comprises:
at least one processor; and
one or more memories coupled to the at least one processor and storing programming instructions for execution by the at least one processor to:
send a first training signal to a second device on a reflection path; and
send a second training signal to the second device on the reflection path, wherein the reflection path is a transmission path formed after the first training signal and the second training signal are reflected by a surrounding object, and wherein an interval between the first training signal and the second training signal corresponds to encoded data.

10. The communication apparatus according to claim 9, wherein the one or more memories store the programming instructions for execution by the at least one processor to:
receive configuration information sent by the second device, wherein the configuration information comprises first indication information, and the first indication information indicates signal types of the first training signal and the second training signal.

11. The communication apparatus according to claim 10, wherein one of the signal types corresponds to one service type.

12. The communication apparatus according to claim 10, wherein one of the signal types corresponds to one first device.

13. The communication apparatus according to claim 10, wherein the configuration information comprises second indication information, and the second indication information indicates a time period in which the communication apparatus sends the first training signal and the second training signal.

14. The communication apparatus according to claim 10, wherein the configuration information further comprises third indication information, and the third indication information indicates whether the communication apparatus receives downlink data sent by the second device.

15. The communication apparatus according to claim 10, wherein the configuration information further comprises fourth indication information, and the fourth indication information indicates at least one of uplink transmission start time, allowable transmission duration, or used frequency band information.

16. The communication apparatus according to claim 9, wherein the one or more memories store the programming instructions for execution by the at least one processor to:
disable a radio frequency circuit within the interval; and
determine the interval between the first training signal and the second training signal by using a counter.

17. A communication apparatus, comprising:
at least one processor; and
one or more memories coupled to the at least one processor and storing programming instructions for execution by the at least one processor to:
receive a first training signal sent by a first device on a reflection path;
receive a second training signal sent by the first device on the reflection path, wherein the reflection path is a transmission path formed after the first training signal and the second training signal are reflected by a surrounding object;
determine an interval between the first training signal and the second training signal; and
determine decoded data based on the interval.

18. The communication apparatus according to claim 17, wherein the one or more memories store the programming instructions for execution by the at least one processor to:
determine a start point of a counter when a second device receives the first training signal;
determine an end point of the counter when the second device detects the second training signal; and
determine the interval based on the start point and the end point.

19. The communication apparatus according to claim 17, wherein the one or more memories store the programming instructions for execution by the at least one processor to:
send configuration information to the first device, wherein the configuration information comprises first indication information, and the first indication information indicates signal types of the first training signal and the second training signal.

20. The communication apparatus according to claim 19, wherein one of the signal types corresponds to one service type.
